(19) United States
(12) Patent Application Publication
(10) Pub. No.: US 2026/0106481 A1
(43) Pub. Date: Apr. 16, 2026

(54) STORAGE BATTERY CONTROL DEVICE, AND POWER STORAGE SYSTEM

(71) Applicant: YAZAKI CORPORATION, Tokyo (JP)

(72) Inventor: Takahiro Syouda, Susono-shi (JP)

(21) Appl. No.: 19/418,903

(22) Filed: Dec. 12, 2025

Related U.S. Application Data
(63) Continuation of application No. PCT/JP2024/022964, filed on Jun. 25, 2024.

(30) Foreign Application Priority Data
Jul. 25, 2023 (JP) 2023-120934

(51) Int. Cl. H02J 7/90; H02J 3/32; H02J 7/50

(52) U.S. Cl. CPC H02J 7/933; H02J 3/32; H02J 7/50; H02J 2207/20

(57) ABSTRACT

A string system controller changes charge and discharge power of the entire power storage system from a current value to a target value by selectively executing one of a standard slope control of individually calculating a string charge and discharge power instruction value of each predetermined cycle for each of string controllers according to a power storage system charge and discharge power instruction value and individually transmitting the string charge and discharge power instruction value to the string controllers for each predetermined cycle, and a shortest slope control of calculating a string charge and discharge power instruction value common to the plurality of string controllers according to the power storage system charge and discharge power instruction value and simultaneously transmitting the common string charge and discharge power instruction value to the plurality of string controllers.

### CROSS-REFERENCE TO RELATED APPLICATIONS

This is a continuation of International Application No. PCT/JP2024/022964 filed on June 25, 2024, and claims priority from Japanese Patent Application No. 2023-120934 filed on July 25, 2023, the entire contents of which are incorporated herein by reference.

### TECHNICAL FIELD

The present disclosure relates to a storage battery control device and a power storage system.

### BACKGROUND ART

There is known a power storage system in which a plurality of battery packs are connected in parallel to a power supply target and a power system via a plurality of power conditioning systems (PCSs) (see Patent Literature 1). The power storage system described in Patent Literature 1 includes an energy management system (EMS), a plurality of buttery management units (BMUs), a plurality of state of charge (SOC) sensors, and the like. The EMS transmits a power instruction value to one master BMU among the plurality of BMUs. The master BMU sets charge and discharge amount instruction values of all the battery packs and transmits the set charge and discharge amount instruction values to all the slave BMUs. Each of the slave BMUs controls a charge and discharge amount of each of the battery packs based on the received charge and discharge amount instruction value and a SOC of a battery pack estimated by SOC estimation.

In addition, as a system that controls discharge of a power storage string in which a plurality of storage batteries are connected in series, there is known a system in which a storage battery that cannot discharge a required current is bypassed and another storage battery is discharged (see Patent Literature 2). Further, as a system that controls charging of a power storage string in which a plurality of storage batteries are connected in series, there is known a system in which a storage battery that cannot be charged with an input current is bypassed and another storage battery is charged (see Patent Literature 3). The power storage systems described in Patent Literatures 2 and 3 each include a first switch that connects or disconnects the storage batteries and a second switch that connects or disconnects a bypass line.

### CITATION LIST

### PATENT LITERATURE

Patent Literature 1: JP2016-167928A

Patent Literature 2: JP2013-31247A

Patent Literature 3: JP2013-31249A

### SUMMARY OF INVENTION

In a case where the battery pack of the power storage system described in Patent Literature 1 is used as the power storage string of the systems described in Patent Literatures 2 and 3, a complicated charge and discharge control is required, and thus an amount of communication between control devices is enormous and a communication time becomes long. As a result, responsiveness to a charge and discharge instruction from a host system is sacrificed, and a power reception point control requiring high-speed response becomes difficult.

In view of the above circumstances, an object of the present disclosure is to provide a storage battery control device and a power storage system capable of improving responsiveness to a charge and discharge instruction in a power storage system in which a plurality of power storage strings are connected in parallel.

The storage battery control device according to the present disclosure is a storage battery control device that controls a power storage system including a plurality of power storage strings connected in parallel, the storage battery control device including: a plurality of first control units that are provided for each of the power storage strings and are configured to control charge and discharge power of a corresponding power storage string; and a second control unit configured to receive a first charge and discharge power instruction value, which is an instruction value of charge and discharge power of the entire power storage system, from a host control unit, calculate a second charge and discharge power instruction value, which is an instruction value of charge and discharge power of each power storage string, according to the received first charge and discharge power instruction value, and transmit the calculated second charge and discharge power instruction value to a corresponding first control unit, in which the second control unit is configured to change the charge and discharge power of the entire power storage system from a current value to a target value by selectively executing one of a first control of individually calculating the second charge and discharge power instruction value of each predetermined cycle for each of the first control units according to the first charge and discharge power instruction value received from the host control unit and individually transmitting the calculated second charge and discharge power instruction value to the first control unit for each predetermined cycle, and a second control of calculating the second charge and discharge power instruction value common to the plurality of first control units according to the first charge and discharge power instruction value received from the host control unit and simultaneously transmitting the calculated common second charge and discharge power instruction value to the plurality of first control units, and execute, after the first control or the second control is executed, a third control of individually calculating the second charge and discharge power instruction value for each of the first control units and individually transmitting the calculated second charge and discharge power instruction value to the first control unit to adjust the charge and discharge power of the plurality of power storage strings.

The power storage system according to the present disclosure is a power storage system including: a plurality of power storage strings connected in parallel; and a storage battery control device that controls charge and discharge power of the plurality of power storage strings, in which the storage battery control device includes a plurality of first control units that are provided for each of the power storage strings and are configured to control charge and discharge power of a corresponding power storage string, and a second control unit configured to receive a first charge and discharge power instruction value, which is an instruction value of charge and discharge power of the entire power storage system, from a host control unit, calculate a second charge and discharge power instruction value, which is an instruction value of charge and discharge power of each power storage string, according to the received first charge and discharge power instruction value, and transmit the calculated second charge and discharge power instruction value to a corresponding first control unit, and the second control unit is configured to change the charge and discharge power of the entire power storage system from a current value to a target value by selectively executing one of a first control of individually calculating the second charge and discharge power instruction value of each predetermined cycle for each of the first control units according to the first charge and discharge power instruction value received from the host control unit and individually transmitting the calculated second charge and discharge power instruction value to the first control unit for each predetermined cycle, and a second control of calculating the second charge and discharge power instruction value common to the plurality of first control units according to the first charge and discharge power instruction value received from the host control unit and simultaneously transmitting the calculated common second charge and discharge power instruction value to the plurality of first control units, and execute, after the first control or the second control is executed, a third control of individually calculating the second charge and discharge power instruction value for each of the first control units and individually transmitting the calculated second charge and discharge power instruction value to the first control unit to adjust the charge and discharge power of the plurality of power storage strings.

According to the present disclosure, the responsiveness to the charge and discharge instruction can be improved in a power storage system in which a plurality of power storage strings are connected in parallel.

### BRIEF DESCRIPTION OF DRAWINGS

FIG. 1 is a circuit diagram illustrating a configuration of a circuit of a power storage system including a storage battery control device according to an embodiment of the present disclosure;

FIG. 2 is a block diagram illustrating a configuration of a control of the power storage system illustrated in FIG. 1;

FIG. 3 is a flowchart for illustrating a process of a string system controller illustrated in FIGS. 1 and 2;

FIG. 4 is a graph illustrating update of a power storage system charge and discharge power instruction value and a string charge and discharge power instruction value of each string;

FIG. 5 is a graph illustrating update of the power storage system charge and discharge power instruction value and the string charge and discharge power instruction value of each string;

FIG. 6 is a table showing a power storage system discharge power instruction value and a string discharge power instruction value of each string at a start timing of a standard slope control in a slope control period of power storage system discharge power;

FIG. 7 is a table showing the power storage system discharge power instruction value and the string discharge power instruction value of each string at a start timing of a shortest slope control in the slope control period of the power storage system discharge power;

FIG. 8 is a table showing a power storage system discharge power instruction value and a string discharge power instruction value of each string at a start timing of a standard slope control of string discharge power;

FIG. 9 is a table showing the power storage system discharge power instruction value and the string discharge power instruction value of each string at the start timing of the shortest slope control in the slope control period of the power storage system discharge power;

FIG. 10 is a table showing the power storage system discharge power instruction value and the string discharge power instruction value of each string at the start timing of the shortest slope control in the slope control period of the power storage system discharge power;

FIG. 11 is a table showing the power storage system discharge power instruction value and the string discharge power instruction value of each string at the start timing of the shortest slope control in the slope control period of the power storage system discharge power; and

FIG. 12 is a table showing the power storage system discharge power instruction value and the string discharge power instruction value of each string at the start timing of the standard slope control of the string discharge power.

### DESCRIPTION OF EMBODIMENTS

Hereinafter, the present disclosure will be described with reference to preferred embodiments. The present disclosure is not limited to the embodiment to be described below, and the embodiment can be appropriately modified without departing from the gist of the present disclosure. In the embodiments to be described below, a part of configurations may not be described or illustrated in the drawings, and regarding details of the omitted techniques, publicly known or well-known techniques will be appropriately applied as long as there is no contradiction with the contents to be described below.

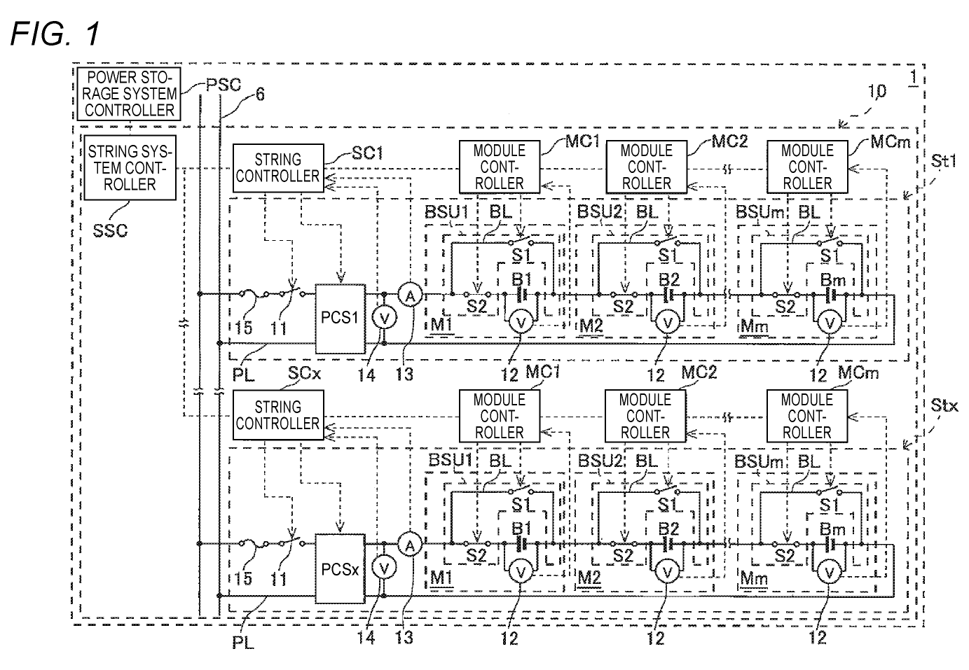

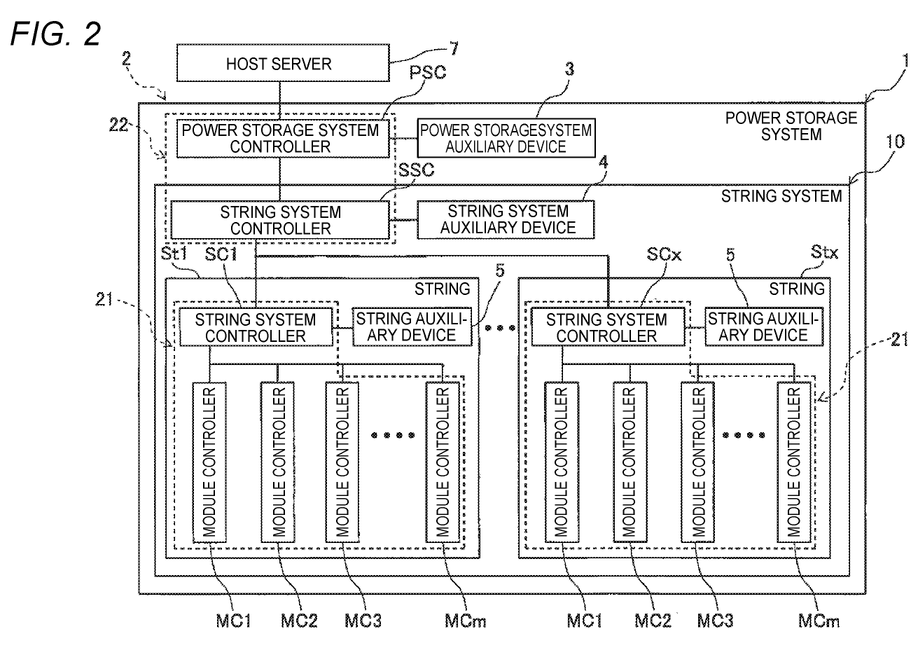

FIG. 1 is a circuit diagram illustrating a configuration of a circuit of a power storage system 1 including a storage battery control device 2 (see FIG. 2) according to an embodiment of the present disclosure. The power storage system 1 illustrated in this drawing is a stationary power supply and includes a string system 10 and a power storage system controller PSC.

The power storage system controller PSC is a control device of the highest hierarchy in the power storage system 1, communicates with a host server 7 (see FIG. 2) and a string system controller SSC, and controls a power storage system auxiliary device 3 (see FIG. 2). In addition, the power storage system controller PSC includes a display input device (not illustrated) such as a touch panel having a display function and an input function.

The string system 10 includes a plurality of strings St1 to Stx, a string bus 6, the string system controller SSC, and a plurality of string controllers SC1 to SCx. The string system controller SSC and the string controllers SC1 to SCx will be described later.

The plurality of strings St1 to Stx are connected in parallel to each other via the string bus 6 and are connected to an external system (not illustrated). Each of the strings St1 to Stx includes each of power converters PCS1 to PCSx, a string cutoff switch 11, a plurality of modules M1 to Mm, and a plurality of module controllers MC1 to MCm. The module controllers MC1 to MCm will be described later.

Each of the modules M1 to Mm includes each of storage batteries B1 to Bm, each of bypass switch units BSU1 to BSUm, and a voltage sensor 12. In each of the strings St1 to Stx, the plurality of storage batteries B1 to Bm are connected in series, and the bypass switch units BSU1 to BSUm are provided for the respective storage batteries B1 to Bm. In addition, each of the strings St1 to Stx includes a current sensor 13, a voltage sensor 14, a fuse 15, the same number of temperature sensors (not illustrated) as the storage batteries B1 to Bm, and the same number of cell voltage sensors (not illustrated) as storage battery cells.

The storage batteries B1 to Bm are secondary batteries such as lithium ion batteries and lithium ion capacitors, are charged by power supplied from the external system through the power converters PCS1 to PCSx, and supply power to the external system by discharging the charged power through the power converters PCS1 to PCSx. Although not particularly limited, the storage batteries B1 to Bm of the present embodiment are obtained by recycling used storage batteries, and there is a difference in degree of deterioration among the respective storage batteries B1 to Bm. The storage batteries B1 to Bm may be a storage battery pack in which a plurality of storage battery modules are connected in series, or may be configured by a single storage battery cell.

Each of the bypass switch units BSU1 to BSUm includes a bypass line BL and switches S1 and S2. The bypass line BL is a power line that bypasses each of the storage batteries B1 to Bm. The switch S1 is provided on the bypass line BL. The switch S1 is, for example, a mechanical switch, a semiconductor switch, or a relay. The switch S2 is provided between a positive electrode of each of the storage batteries B1 to Bm and one end of the bypass line BL. The switch S2 is, for example, a mechanical switch, a semiconductor switch, or a relay.

The storage battery B1 at a starting end and the storage battery Bm at a terminal end are connected to the external system via the power converters PCS1 to PCSx and the string bus 6. In a case where the switch S1 is turned off and the switch S2 is turned on in all the bypass switch units BSU1 to BSUm, all the storage batteries B1 to Bm are connected in series to the external system. On the other hand, in a case where the switch S2 is turned off and the switch S1 is turned on in any of the bypass switch units BSU1 to BSUm, the storage batteries B1 to Bm corresponding to the bypass switch units BSU1 to BSUm are bypassed.

The power converters PCS1 to PCSx are bidirectional converters and are connected to the string bus 6. In addition, the power converters PCS1 to PCSx are each connected to a positive electrode of the storage battery B1 at a starting end and a negative electrode of the storage battery Bm at a terminal end.

When the strings St1 to Stx are charged, the power converters PCS1 to PCSx convert a voltage input from the string bus 6 according to a string charge power instruction value and output the converted voltage to the plurality of storage batteries B1 to Bm. Here, a voltage on a side of the strings St1 to Stx changes according to a bypass state of the storage batteries B1 to Bm (the number of bypassed storage batteries B1 to Bm) and a charge state of the storage batteries B1 to Bm. Therefore, when the strings St1 to Stx are charged, the power converters PCS1 to PCSx convert the voltage input from the string bus 6 into the voltage on the side of the strings St1 to Stx and output the converted voltage to the plurality of storage batteries B1 to Bm.

When the strings St1 to Stx are discharged, the power converters PCS1 to PCSx convert voltages input from the plurality of storage batteries B1 to Bm according to the string discharge power instruction value and output the converted voltages to the string bus 6. Here, input voltages of the power converters PCS1 to PCSx at the time of discharge change according to the bypass state of the storage batteries B1 to Bm and the charge state of the storage batteries B1 to Bm. This causes variations in the input voltages of the power converters PCS1 to PCSx among the strings St1 to Stx at the time of discharge. Therefore, when the strings St1 to Stx are discharged, the power converters PCS1 to PCSx convert the input voltages into voltages that match other strings St1 to Stx and output the converted voltages to the string bus 6. In a case where a current flowing through the string bus 6 is an alternating current, the power converters PCS1 to PCSx each include a synchronization unit for following a change in an instantaneous value.

Each string cutoff switch 11 is provided between each of the power converters PCS1 to PCSx and the string bus 6. The string cutoff switch 11 connects or cuts off the strings St1 to Stx to or from the string bus 6. In addition, each fuse 15 is a power fuse provided between each string cutoff switch 11 and the string bus 6.

The voltage sensor 12 is connected between positive and negative electrode terminals of each of the storage batteries B1 to Bm, detects a voltage between the terminals of each of the storage batteries B1 to Bm, and transmits a detection signal to each of the module controllers MC1 to MCm. The current sensor 13 is provided on a power line PL of each of the strings St1 to Stx, detects a charge and discharge current of each of the strings St1 to Stx (hereinafter, referred to as string current), and transmits a detection signal to each of the string controllers SC1 to SCx. The voltage sensor 14 is provided on the power line PL of each of the strings St1 to Stx, detects a total voltage of the respective strings St1 to Stx (hereinafter, referred to as total string voltage), and transmits a detection signal to each of the string controllers SC1 to SCx.

The temperature sensor is provided in each of the storage batteries B1 to Bm, detects a temperature of each of the storage batteries B1 to Bm, and transmits a detection signal to each of the module controllers MC1 to MCm. Further, the cell voltage sensor is provided for each storage battery cell of each of the storage batteries B1 to Bm, detects a voltage of each storage battery cell, and transmits a detection signal to each of the module controllers MC1 to MCm.

FIG. 2 is a block diagram illustrating a configuration of a control of the power storage system 1 illustrated in FIG. 1. As illustrated in this drawing, the power storage system 1 includes the storage battery control device 2. The storage battery control device 2 includes a plurality of first control devices 21 and a second control device 22. Each of the first control devices 21 includes each of the string controllers SC1 to SCx and a plurality of module controllers MC1 to MCm. The second control device 22 includes the power storage system controller PSC and the string system controller SSC.

The power storage system controller PSC, the string system controller SSC, the string controllers SC1 to SCx, and the module controllers MC1 to MCm are provided for each hierarchy. The power storage system controller PSC corresponds to a hierarchy of the power storage system 1 of the highest order. The string system controller SSC corresponds to a hierarchy of the string system 10 subsequent to the hierarchy of the power storage system 1. The string controllers SC1 to SCx correspond to a hierarchy of the respective strings St1 to Stx subsequent to the hierarchy of the string system 10. The module controllers MC1 to MCm correspond to a hierarchy of the respective modules M1 to Mm (see FIG. 1) subsequent to the hierarchy of the respective strings St1 to Stx.

The power storage system controller PSC communicates with the host server 7 and the string system controller SSC, and controls and manages the power storage system auxiliary device 3. The host server 7 is provided in a facility of an aggregator, a power receiving facility in a building or a factory, or the like. The host server 7 calculates a charge and discharge power instruction value for the entire power storage system 1 (hereinafter, referred to as power storage system charge and discharge power instruction value) according to a state of the power storage system 1 and a power demand on a demand side, and transmits the charge and discharge power instruction value to the power storage system controller PSC.

Examples of the power storage system auxiliary device 3 include a temperature sensor that detects a temperature of an installation environment of the power storage system 1 such as a container, a fire extinguishing facility, and the like (all of which are not illustrated). In a case where a detected value of the temperature sensor exceeds a threshold value, the power storage system controller PSC determines that the temperature of the installation environment of the power storage system 1 is abnormal, and outputs an abnormality notification to the display input device. In addition, the power storage system controller PSC monitors an operating state of the fire extinguishing system.

The power storage system controller PSC receives information on states of the strings St1 to Stx (hereinafter, referred to as string state information) and information on a state of the string system 10 (hereinafter, referred to as string system state information) from the string system controller SSC, and outputs the information to the host server 7 and the display input device.

Examples of the states of the strings St1 to Stx include operation states such as charge, discharge, pause, and maintenance, the string current, the total string voltage, a SOC of the strings St1 to Stx (hereinafter, referred to as string SOC), a state of health (SOH) of the strings St1 to Stx (hereinafter, referred to as string SOH), and limit values of charge and discharge power (or charge and discharge current) of the strings St1 to Stx (hereinafter, referred to as string charge and discharge power limit value), and the like.

Examples of the state of the string system 10 include a current of the string bus 6 (see FIG. 1) (hereinafter, referred to as string bus current), a voltage of the string bus 6 (hereinafter, referred to as string bus voltage), a SOC of the string system 10 (hereinafter, referred to as string system SOC), a SOH of the string system 10 (hereinafter, referred to as string system SOH), and a limit value of charge and discharge power (or charge and discharge current) of the string system 10 (hereinafter, referred to as string system charge and discharge power limit value).

The power storage system controller PSC estimates the state of the power storage system 1 based on the string state information and the string system state information received from the string system controller SSC. Examples of the state of the power storage system 1 include operation states such as charge, discharge, pause, and maintenance, a SOC of the power storage system 1 (hereinafter, referred to as power storage system SOC), and a SOH of the power storage system 1 (hereinafter, referred to as power storage system SOH). The power storage system controller PSC outputs information on the estimated state of the power storage system 1 (hereinafter, referred to as power storage system state information) to the display input device as necessary. In the present embodiment in which the string system 10 is single, the string system SOC is equal to the power storage system SOC, and the string SOH is equal to the power storage system SOH.

The power storage system controller PSC transmits information required for a process of the host server 7 to the host server 7. Examples of the information required for the process of the host server 7 include the power storage system SOC, the power storage system SOH, and the string system charge and discharge power limit value. Here, the host server 7 determines a charge and discharge instruction corresponding to the power storage system 1 based on the "information required for the process of the host server 7" received from the power storage system controller PSC, and transmits the charge and discharge instruction to the power storage system controller PSC. Examples of the charge and discharge instruction include, in addition to the power storage system charge and discharge power instruction value, control amounts in a constant voltage (CV) mode, a constant current (CC) mode, and a constant power (CP) mode, and an operation method such as a self-sustained operation or a system interconnection.

The power storage system controller PSC transmits various kinds of instruction information input by an operator or the like through the display input device to the string system controller SSC. Examples of the various kinds of instruction information that can be input through the display input device include information of an instruction to execute a maintenance and stop mode (hereinafter, referred to as maintenance and stop instruction), an instruction to forcibly execute charge and discharge, an instruction to forcibly execute state estimation, and the like.

Examples of the maintenance and stop instruction include an instruction to forcibly cause the power storage system auxiliary device 3, a string system auxiliary device 4, and a string auxiliary device 5 to operate. By forcibly causing the power storage system auxiliary device 3, the string system auxiliary device 4, and the string auxiliary device 5 to operate, operations of the power storage system auxiliary device 3, the string system auxiliary device 4, and the string auxiliary device 5 can be confirmed.

Examples of the instruction to forcibly execute charge and discharge include an instruction to specify a predetermined charge and discharge amount and forcibly cause the power storage system 1 to execute charge and discharge. By specifying the predetermined charge and discharge amount and forcibly causing the power storage system 1 to execute the charge and discharge, whether the power storage system 1 can charge and discharge the specified predetermined charge and discharge amount can be confirmed.

Examples of the instruction to forcibly execute the state estimation include an instruction to specify an item of predetermined state estimation and forcibly cause the power storage system 1 to execute the state estimation. By specifying the item of the predetermined state estimation and forcibly causing the power storage system 1 to execute the state estimation, for example, the item of the state estimation such as the string system SOH and the power storage system SOH can be acquired at any timing.

The string system controller SSC communicates with the power storage system controller PSC and the plurality of string controllers SC1 to SCx, and controls and manages the string system auxiliary device 4. Examples of the string system auxiliary device 4 include a temperature sensor that detects an atmospheric temperature, a cooling device in the string system 10, a cutoff device of the string bus 6, a current sensor that detects a string bus current, and a voltage sensor that detects a string bus voltage (all of which are not illustrated).

The string system controller SSC receives the string state information from the string controllers SC1 to SCx. Examples of the states of the strings St1 to Stx include operation states such as charge, discharge, pause, and maintenance, the string current, the total string voltage, the string SOC, the string SOH, the string charge and discharge power limit value, and a state of the string system auxiliary device 4. Examples of the state of the string system auxiliary device 4 include the string bus current and the string bus voltage.

The string system controller SSC estimates the state of the string system 10 based on the string state information received from the string controllers SC1 to SCx. Examples of the state of the string system 10 include the string bus current, the string bus voltage, the string system SOC, the string system SOH, and the string system charge and discharge power limit value. The state of the string system 10 may be estimated by the power storage system controller PSC. The power storage system controller PSC may receive the string state information from the string system controller SSC to estimate the state of the string system 10, and estimate the state of the power storage system 1 based on an estimation result thereof.

For example, in a case where detected values of the temperature sensor, the current sensor, and the voltage sensor or an estimated value of the state of the string system 10 exceeds a range of a threshold value, the string system controller SSC determines whether there is an abnormality in the string system 10, stops the operation of the string system 10, and transmits an abnormality notification to the power storage system controller PSC.

The string system controller SSC transmits, to the power storage system controller PSC, information required for a process of the power storage system controller PSC among information received from the string controllers SC1 to SCx and information estimated by the string system controller SSC. Examples of the information required for the process of the power storage system controller PSC include the string system SOC, the string system SOH, and the string system charge and discharge power limit value.

Here, the power storage system controller PSC determines an instruction corresponding to the string system 10 based on the "information required for the process of the power storage system controller PSC" received from the string system controller SSC, and transmits instruction information to the string system controller SSC. Examples of the instruction include a charge and discharge instruction for the string system 10 in a charge and discharge mode, an instruction to individually control each unit of the string system 10 (hereinafter, referred to as individual control instruction) in a maintenance mode, and a state estimation instruction for the string system 10 in a state estimation mode. Examples of the charge and discharge instruction of the string system 10 in the charge and discharge mode include, in addition to the string charge and discharge power instruction value assigned to each of the strings St1 to Stx, instructions of a slope control mode to be described later, the control amounts in the constant voltage (CV) mode, the constant current (CC) mode, and the constant power (CP) mode, the operation method such as a self-sustained operation or a system interconnection. Examples of the individual control instruction of the string system 10 in the maintenance mode include an instruction to individually control the string system auxiliary device 4 such as the power converters PCS1 to PCSx, the cooling device, and the switches S1 and S2. Examples of the state estimation instruction for the string system 10 in the state estimation mode include an execution instruction of a predetermined control required for executing the state estimation of each of the strings St1 to Stx.

The string system controller SSC receives the above-described instruction corresponding to the string system 10 from the power storage system controller PSC, and determines whether the operation state of the string system 10 needs to be updated by comparing the currently received instruction with the previously received instruction. In a case where it is determined that the operation state of the string system 10 needs to be updated, the string system controller SSC determines an operation mode of each of the strings St1 to Stx, permission for a bypass request (hereinafter, referred to as bypass permission) from each of the string controllers SC1 to SCx, and the string charge and discharge power instruction value assigned to each of the strings St1 to Stx. Examples of the operation mode of each of the strings St1 to Stx include the charge and discharge mode, the state estimation mode, the maintenance and stop mode, and the like.

Here, the string system controller SSC determines the operation mode of each of the strings St1 to Stx, the bypass permission, and the string charge and discharge power instruction value based on an operation history of each of the strings St1 to Stx from the past to the present. The determination of the operation mode or the like based on the operation history from the past to the present includes the following (1) to (4).

(1) Determine whether to execute the state estimation of each of the strings St1 to Stx based on an execution timing of the state estimation of each of the strings St1 to Stx.

(2) Determine whether to execute maintenance of each of the strings St1 to Stx or to execute charge and discharge of each of the strings St1 to Stx based on whether abnormality determination of each of the strings St1 to Stx is executed and a timing thereof.

(3) Determine the string charge and discharge power instruction value of each of the strings St1 to Stx according to whether there is a bypass request from each of the string controllers SC1 to SCx. For example, determine the string charge and discharge power instruction value of the strings St1 to Stx corresponding to the string controllers SC1 to SCx from which the bypass request is transmitted to be 0. After a bypass control of the strings St1 to Stx is completed, increase the string charge and discharge power instruction value for the strings St1 to Stx.

(4) Determine the string charge and discharge power instruction value of each of the strings St1 to Stx based on the string SOC, the string SOH, and the total string voltage of each of the strings St1 to Stx.

The string controllers SC1 to SCx communicate with the string system controller SSC and the plurality of module controllers MC1 to MCm, and control and manage the string auxiliary device 5. Examples of the string auxiliary device 5 include the power converters PCS1 to PCSx, the current sensor 13 that detects the string current, the voltage sensor 14 that detects the total string voltage, and the string cutoff switch 11 (see FIG. 1 for all).

The string controllers SC1 to SCx receive information on states of the storage batteries B1 to Bm (hereinafter, referred to as storage battery state information) from the module controllers MC1 to MCm. Examples of the states of the storage batteries B1 to Bm include a temperature, a current, a voltage, and a cell voltage of the storage batteries B1 to Bm, states of the bypass switch units BSU1 to BSUm, and the like.

The string controllers SC1 to SCx estimate a SOC, a SOH, a charge and discharge power limit value, and the like of the storage batteries B1 to Bm based on the storage battery state information received from the module controllers MC1 to MCm. The estimation of the SOC, the SOH, the charge and discharge power limit value, and the like of the storage batteries B1 to Bm may be executed by the module controllers MC1 to MCm. In this case, the module controllers MC1 to MCm may transmit an estimation result thereof to the string controllers SC1 to SCx.

The string controllers SC1 to SCx estimate the states of the strings St1 to Stx based on the storage battery state information received from the module controllers MC1 to MCm. Examples of the states of the strings St1 to Stx include the string SOH, the string SOC, and the string charge and discharge power limit value. The estimation of the states of the strings St1 to Stx may be executed by the string system controller SSC. In this case, the string controllers SC1 to SCx may transmit the storage battery state information and an estimation result of the state of the storage battery to the string system controller SSC.

For example, in a case where detected values of the current sensor 13 and the voltage sensor 14 or estimated values of the states of the strings St1 to Stx are out of a range of a threshold value, the string controllers SC1 to SCx determine whether there is an abnormality in the strings St1 to Stx. In this case, the string controllers SC1 to SCx stop the operation of the strings St1 to Stx or transmit an abnormality notification to the string system controller SSC.

The string controllers SC1 to SCx transmit, to the string system controller SSC, information required for a process of the string system controller SSC among the information received from the module controllers MC1 to MCm and the information estimated by the string controllers SC1 to SCx. Examples of the information required for the process of the string system controller SSC include the temperature, the current, the voltage, the SOC, the SOH, the charge and discharge power limit value, and the cell voltage of the storage batteries B1 to Bm, the states of the bypass switch units BSU1 to BSUm, the string SOC, the string SOH, and the string charge and discharge power limit value.

Here, the string system controller SSC determines an instruction corresponding to each of the strings St1 to Stx based on the "information required for the process of the string system controller SSC" received from the string controllers SC1 to SCx, and transmits instruction information to the string controllers SC1 to SCx. Examples of the instruction include a charge and discharge instruction of each of the strings St1 to Stx in the charge and discharge mode, an individual control instruction of each of the strings St1 to Stx in the maintenance mode, and a state estimation instruction of each of the strings St1 to Stx in the state estimation mode. Examples of an item of the charge and discharge instruction of each of the strings St1 to Stx in the charge and discharge mode include, in addition to the string charge and discharge power instruction value, the control amounts in the constant voltage mode, the constant current mode, and the constant power mode, and the operation method such as a self-sustained operation or a system interconnection. Examples of an item of the individual control instruction of each of the strings St1 to Stx in the maintenance mode include an instruction to individually control the bypass switch units BSU1 to BSUm. Examples of an item of the state estimation instruction in the state estimation mode include executing charge and discharge at a constant current and recording the voltage between the terminals of the storage batteries B1 to Bm at that time.

The string controllers SC1 to SCx receive the above-described instruction information corresponding to each of the strings St1 to Stx from the string system controller SSC, and determine whether a bypass schedule of each of the strings St1 to Stx needs to be updated by comparing the currently received instruction information with the previously received instruction information. The bypass schedule of each of the strings St1 to Stx is a plan related to bypassing of the storage batteries B1 to Bm by the bypass switch units BSU1 to BSUm, and is determined based on a predetermined reference. The string controllers SC1 to SCx determine whether switching of charge to discharge or discharge to charge is executed in each of the strings St1 to Stx, and determine that the bypass schedule needs to be updated in a case where the switching is executed. In a case where the bypass schedule needs to be updated, the string controllers SC1 to SCx determine the bypass schedule of the storage batteries B1 to Bm based on the storage battery state information received from the module controllers MC1 to MCm and an estimation result of the states of the storage batteries B1 to Bm.

On the other hand, the string controllers SC1 to SCx determine whether string charge and discharge power needs to be controlled by comparing the current and previous storage battery state information received from the module controllers MC1 to MCm and the current and previous estimation results of the states of the storage batteries B1 to Bm. The string controllers SC1 to SCx control the power converters PCS1 to PCSx in a case where the control of the string charge and discharge power is required.

The string controllers SC1 to SCx control the power converters PCS1 to PCSx according to the string charge and discharge power instruction value received from the string system controller SSC.

In a case where the maintenance and stop instruction is received from the string system controller SSC, the string controllers SC1 to SCx analyze the received maintenance and stop instruction, and determine a type of maintenance to be executed. Examples of the type of the maintenance include an individual control, self-diagnosis, replacement of the storage batteries B1 to Bm (hereinafter, referred to as storage battery replacement), and the like.

Examples of the individual control include a control of individually turning on and off the string cutoff switch 11, the cooling devices in the strings St1 to Stx, and the like. Examples of the self-diagnosis include executing abnormality determination for determining an abnormality that determination is difficult to be executed during operation in the state estimation mode or the charge and discharge mode. Examples of the abnormality determination include executing a specific control on the string auxiliary device 5 such as the power converters PCS1 to PCSx and the bypass switch units BSU1 to BSUm, and acquiring responses thereof by various sensors to determine whether there is an abnormality. Examples of the storage battery replacement include guiding the storage battery replacement for the storage batteries B1 to Bm in which progress of deterioration, failure, or the like occurs. When the storage battery replacement is executed, a work guide is displayed on the display input device of the power storage system controller PSC, and a necessary control such as stopping the strings St1 to Stx to be subjected to the storage battery replacement is executed in the power storage system 1. The strings St1 to Stx not subjected to the storage battery replacement may be caused to operate in the charge and discharge mode. After the storage battery replacement is completed, the strings St1 to Stx in which the storage battery replacement is executed are operated in the state estimation mode, and the storage battery state information is transmitted from the module controllers MC1 to MCm to the string controllers SC1 to SCx. The strings St1 to Stx not subjected to the storage battery replacement may be caused to operate in the charge and discharge mode.

In a case where the state estimation instruction is received from the string system controller SSC, the string controllers SC1 to SCx compare the currently received string charge and discharge power instruction value with the previously received string charge and discharge power instruction value, and determine whether there is a change. In a case where there is a change in the string charge and discharge power instruction value between the previous time and the current time, the string controllers SC1 to SCx control the string auxiliary device 5 and the bypass switch units BSU1 to BSUm by a predetermined method such that the state estimation of the strings St1 to Stx can be executed. Examples of the method for controlling the string auxiliary device 5 at the time of executing the state estimation mode include a method for executing a constant current control on the power converters PCS1 to PCSx by turning on the string cutoff switch 11. In addition, examples of the method for controlling the bypass switch units BSU1 to BSUm at the time of executing the state estimation mode include a method for sequentially bypassing the storage batteries B1 to Bm which are fully discharged at the time of discharge.

The string controllers SC1 to SCx record the storage battery state information received from the module controllers MC1 to MCm. In addition, the string controllers SC1 to SCx update parameters used when the state estimation is executed as necessary based on the storage battery state information received from the module controllers MC1 to MCm. Examples of the parameters include the SOH of the storage batteries B1 to Bm, a map of charge and discharge limit values of the storage batteries B1 to Bm, and SOC-OCV characteristics.

The module controllers MC1 to MCm communicate with the string controllers SC1 to SCx, and control and manage a module auxiliary device (not illustrated). Examples of the module auxiliary device include the bypass switch units BSU1 to BSUm and various sensors. Examples of the various sensors include a voltage sensor that detects a voltage of the storage batteries B1 to Bm, a current sensor that detects a current of the storage batteries B1 to Bm, a temperature sensor that detects a temperature of the storage batteries B1 to Bm, and a cell voltage sensor that detects a cell voltage.

The module controllers MC1 to MCm receive the storage battery state information from a cell monitoring unit (not illustrated) or the like. Examples of the states of the storage batteries B1 to Bm include a total voltage of the storage batteries B1 to Bm, the temperature of the storage batteries B1 to Bm, and the cell voltage. The cell monitoring unit receives detection signals from various sensors such as a module voltage sensor that detects a module voltage, a cell voltage sensor that detects a cell voltage, and a module temperature sensor that detects a module temperature. The cell monitoring unit may be configured as a single unit, or may be configured using a battery cell monitoring integrated circuit (IC) in the module controllers MC1 to MCm.

The module controllers MC1 to MCm receive the storage battery state information from the above-described cell monitoring unit or various sensors of the storage batteries B1 to Bm, and estimate the states of the storage batteries B1 to Bm based on the received information. Examples of the states of the storage batteries B1 to Bm to be estimated include the SOC, the SOH, the charge and discharge power limit value, and the like of the storage batteries B1 to Bm. The states of the storage batteries B1 to Bm may be estimated by the string controllers SC1 to SCx.

For example, in a case where detected values of the voltage sensor, the cell voltage sensor, and the module temperature sensor or estimated values of the states of the storage batteries B1 to Bm are out of a range of a threshold value, the module controllers MC1 to MCm determine whether there is an abnormality in the storage batteries B1 to Bm. The module controllers MC1 to MCm cut off, by the bypass switch units BSU1 to BSUm, the storage batteries B1 to Bm for which the abnormality determination is executed, or transmit an abnormality notification to the string controllers SC1 to SCx.

The module controllers MC1 to MCm transmit, to the string controllers SC1 to SCx, information required for a process of a host controller such as the string controllers SC1 to SCx among information received from the cell monitoring unit or the various sensors and information estimated by the module controllers MC1 to MCm. Examples of the information required for the process of the string controllers SC1 to SCx include the temperature, the current, the voltage, the SOC, the SOH, the charge and discharge power limit value, and the cell voltage of the storage batteries B1 to Bm, and the states of the bypass switch units BSU1 to BSUm.

Here, the string controllers SC1 to SCx determine an instruction corresponding to each of the storage batteries B1 to Bm based on the "information required for the process of the string controllers SC1 to SCx" received from the module controllers MC1 to MCm, and transmit instruction information to the module controllers MC1 to MCm. Examples of the instruction include a bypass control of the storage batteries B1 to Bm by the bypass switch units BSU1 to BSUm, and a cutoff control of the storage batteries B1 to Bm by the bypass switch units BSU1 to BSUm.

In a case where there is a change in the current and previous instruction information received from the string controllers SC1 to SCx, the module controllers MC1 to MCm control the bypass switch units BSU1 to BSUm and execute the above-described bypass control or cutoff control. In addition, in a case where there is a change in the information received from the cell monitoring unit or the various sensors and the information estimated by the module controllers MC1 to MCm, the module controllers MC1 to MCm execute an exception control which does not depend on the instruction from the host controller as necessary. Further, the module controllers MC1 to MCm transmit an instruction to execute cell balancing on the storage batteries B1 to Bm to the cell monitoring unit.

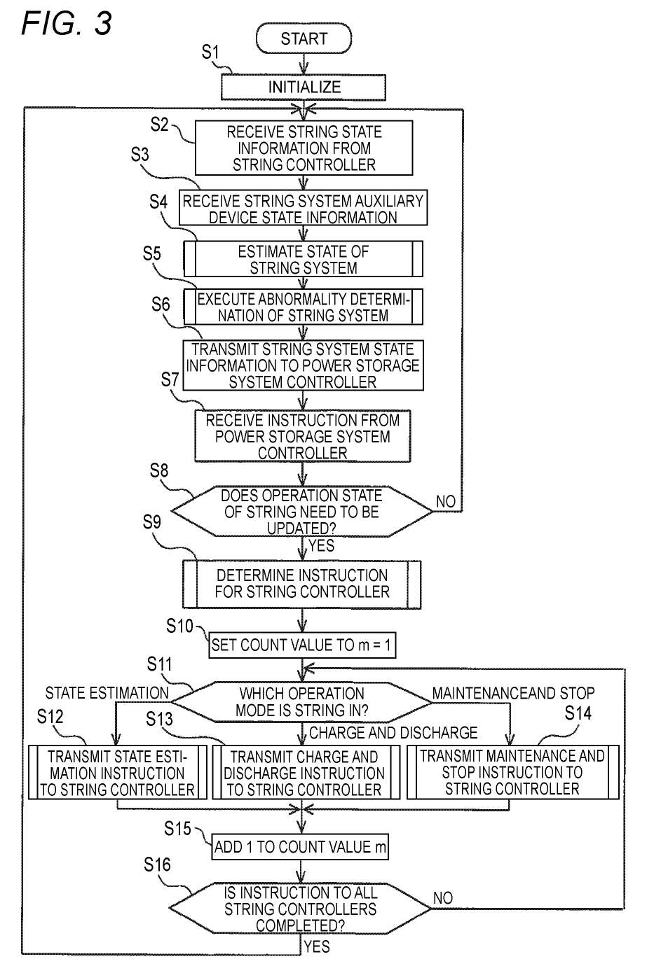

FIG. 3 is a flowchart for illustrating a process of a string system controller SSC illustrated in FIGS. 1 and 2. When the power storage system 1 is operated, a process of step S1 is started, and processes of steps S2 to S16 are repeated while the power storage system 1 is operated.

In step S1, the string system controller SSC initializes various parameters. Next, in step S2, the string system controller SSC receives the string state information from each of the string controllers SC1 to SCx.

Next, in step S3, the string system controller SSC receives string system auxiliary device state information (string bus voltage, string bus current, and the like) from the string system auxiliary device 4.

Next, in step S4, the string system controller SSC estimates the state of the string system 10 based on the string state information received in step S2 and the string system auxiliary device state information received in step S3. The estimation of the state of the string system 10 may be executed by the power storage system controller PSC, and an estimation result thereof may be transmitted from the power storage system controller PSC to the string system controller SSC or the host server 7.

Next, in step S5, the string system controller SSC analyzes the information received or estimated in steps S2 to S4 and determines whether there is an abnormality in the string system 10. The string system controller SSC determines whether there is an abnormality in the string system 10 by, for example, comparing various detected values or estimated values received in steps S2 to S4 with a threshold value.

Next, in step S6, the string system controller SSC transmits, to the power storage system controller PSC, information (string system state information) required for processes of the power storage system controller PSC and the host server 7 among information received, estimated, or determined in steps S2 to S5. Next, in step S7, the string system controller SSC receives an instruction transmitted from the power storage system controller PSC. Here, the power storage system controller PSC determines an instruction corresponding to the string system 10 (power storage system charge and discharge power instruction value in charge and discharge mode) based on the information received from the string system controller SSC in step S6, and transmits the instruction to the string system controller SSC in step S7.

Next, in step S8, the string system controller SSC compares the current and previous instructions received from the power storage system controller PSC, and determines whether operation states of the strings St1 to Stx need to be updated. For example, in a case where there is a change in power storage system charge and discharge power instruction values received from the power storage system controller PSC between the previous time and the current time, the string system controller SSC determines that the operation states of the strings St1 to Stx need to be updated. In addition, for example, in a case where there is a change in individual control instructions in the maintenance mode received from the power storage system controller PSC between the previous time and the current time, the string system controller SSC determines that the operation states of the strings St1 to Stx need to be updated. In a case where the determination in step S8 is YES, the process proceeds to step S9, and in a case where the determination in step S8 is NO, the process proceeds to step S2.

Next, in step S9, the string system controller SSC determines an instruction for each of the string controllers SC1 to SCx according to a predetermined condition. Examples of the predetermined condition include the state of each of the strings St1 to Stx acquired in step S2, the operation history of each of the strings St1 to Stx from the past to the present, and various instructions input through the display input device. Examples of an item of the instruction for each of the string controllers SC1 to SCx include the operation mode (state estimation mode, charge and discharge mode, maintenance and stop mode, and the like) of each of the strings St1 to Stx, permission and non-permission for the bypass request from each of the string controllers SC1 to SCx, and assignment of the string charge and discharge power instruction value to each of the strings St1 to Stx. In a case where the maintenance and stop instruction is input through the display input device, the string system controller SSC determines the instruction for each of the strings St1 to Stx to be the maintenance and stop instruction. Similarly, in a case where the instruction to forcibly execute charge and discharge or state estimation is input through the display input device of the power storage system controller PSC, the string system controller SSC determines the instruction for each of the strings St1 to Stx to be the charge and discharge instruction or the state estimation instruction.

Next, in step S10, the string system controller SSC sets a count value m for managing transmission of instruction information for the string controllers SC1 to SCx to an initial value (m = 1). Next, in step S11, the string system controller SSC determines whether the operation mode of the strings St1 to Stx to be instructed is any of the charge and discharge mode, the state estimation mode, and the maintenance and stop mode. In the case of the charge and discharge mode, the process proceeds to step S13, in the case of the state estimation mode, the process proceeds to step S12, and in the case of the maintenance and stop mode, the process proceeds to step S14.

In step S12, the string system controller SSC transmits the state estimation instruction to the string controllers SC1 to SCx to be instructed. Examples of an item of the state estimation instruction include ON of a state estimation mode flag, the string charge and discharge power instruction value, and bypass permission and non-permission. In the state estimation mode of each of the strings St1 to Stx, for example, discharge is executed with a constant current, and data such as a voltage is acquired during the discharge. Here, in a case where there is a variation in the degree of deterioration of the storage batteries B1 to Bm in each of the strings St1 to Stx, the storage batteries B1 to Bm reach a full discharge state in descending order of the degree of deterioration. Each time the storage batteries B1 to Bm reach the full discharge state, a bypass request is transmitted from the module controllers MC1 to MCm. Accordingly, the string system controller SSC determines whether to notify a bypass permission in response to the received bypass request, and transmits a notification of bypass permission and non-permission to the string controllers SC1 to SCx.

On the other hand, in step S13, the string system controller SSC transmits the charge and discharge instruction to the string controllers SC1 to SCx to be instructed. Examples of an item of the charge and discharge instruction include ON of a charge and discharge mode flag, the string charge and discharge power instruction value, and the bypass permission and non-permission. In a case where fully discharged or fully charged storage batteries B1 to Bm are present, the bypass request is transmitted from the module controllers MC1 to MCm. Accordingly, the string system controller SSC determines whether to notify a bypass permission in response to the received bypass request, and transmits a notification of bypass permission and non-permission to the string controllers SC1 to SCx.

On the other hand, in step S14, the string system controller SSC transmits the maintenance and stop instruction to the string controllers SC1 to SCx to be instructed. Examples of an item of the maintenance and stop instruction include ON of a maintenance and stop flag, various instructions, and the bypass permission and non-permission. The various instructions are instructions corresponding to the instructions input through the display input device. Examples of the instructions include instructions to forcibly cause the power storage system auxiliary device 3, the string system auxiliary device 4, the string auxiliary device 5, and the bypass switch units BSU1 to BSUm to operate. Here, in a case where the instruction to forcibly cause the bypass switch units BSU1 to BSUm to operate is input through the display input device, the string system controller SSC transmits an instruction of bypass permission and non-permission to the string controllers SC1 to SCx. The maintenance and stop instruction is not limited to the case of being input through the display input device, and may be transmitted when an abnormality occurs or may be periodically transmitted.

The process proceeds from steps S12, S13, and S14 to step S15, and in step S15, the string system controller SSC adds 1 to the count value m for managing the transmission of the instruction information to the string controllers SC1 to SCx. Next, in step S16, the string system controller SSC determines whether the transmission of the instruction to all the string controllers SC1 to SCx is completed. Specifically, the string system controller SSC determines whether the count value m reaches a total number x of the string controllers SC1 to SCx. In a case where the determination in step S16 is NO, the process proceeds to step S11, and steps S11 to S16 are repeated. On the other hand, in a case where the determination in step S16 is YES, the process proceeds to step S2, and the processes in steps S2 to S16 are repeated during the operation of the power storage system 1.

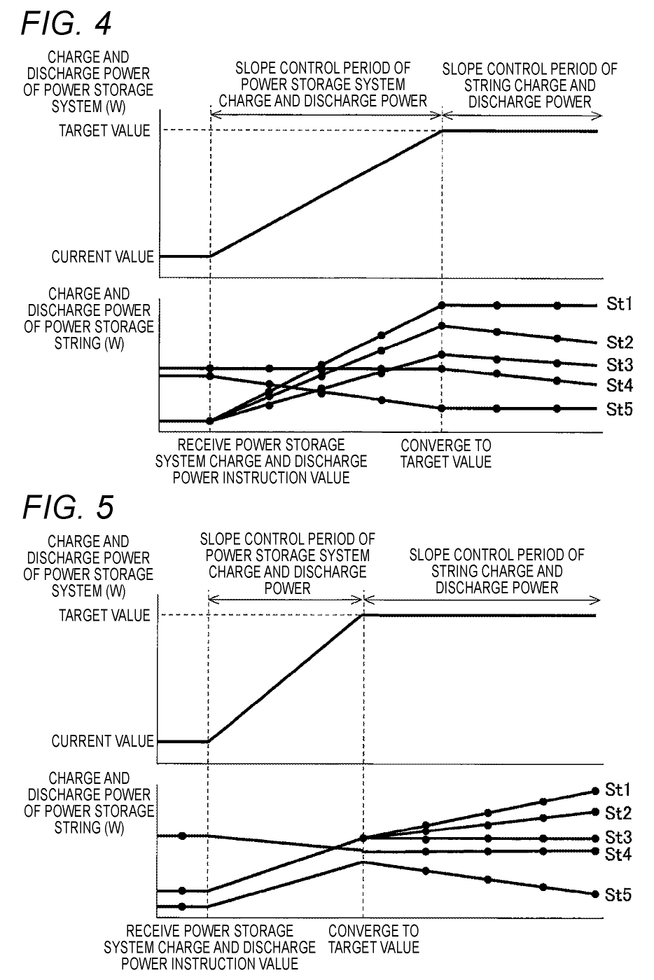

FIGS. 4 and 5 are graphs illustrating update of the power storage system charge and discharge power instruction value and the string charge and discharge power instruction value of each of the strings St1 to Stx. As illustrated in the graphs, the power storage system charge and discharge power instruction value is updated so as to change from a current value to a target value over a predetermined period (slope control period of power storage system charge and discharge power in drawing).

After the power storage system charge and discharge power instruction value is updated, the power storage system charge and discharge power instruction value is maintained, and the string charge and discharge power instruction value of each of the strings St1 to Stx is updated. The string charge and discharge power instruction value of each of the strings St1 to Stx is updated so as to gradually change to a target value over a predetermined period (slope control period of string charge and discharge power in drawing). The update of the string charge and discharge power instruction value of each of the strings St1 to Stx after the update of the power storage system charge and discharge power instruction value is executed for a purpose of adjusting a balance of the charge and discharge power between the strings St1 to Stx.

The graph in FIG. 4 shows, when a control (hereinafter, referred to as standard slope control) of reducing a response speed of the update of the power storage system charge and discharge power instruction value is executed, a relation between the power storage system charge and discharge power instruction value, the string charge and discharge power instruction value of each of the strings St1 to Stx, and a time. The standard slope control is executed for the purpose of preventing a rapid change in the power storage system charge and discharge power at the time of the update of the power storage system charge and discharge power instruction value.

The graph in FIG. 5 shows, when a control (hereinafter, referred to as shortest slope control) of increasing the response speed of updating the power storage system charge and discharge power instruction value is executed, a relation between the power storage system charge and discharge power instruction value, the string charge and discharge power instruction value of each of the strings St1 to Stx, and a time. The shortest slope control is executed for the purpose of high-speed response at the time of the update of the power storage system charge and discharge power instruction value.

As illustrated in the graph of FIG. 4, when the standard slope control is executed, the power storage system charge and discharge power instruction value changes from the current value to the target value over a longer slope control period (for example, 1.3 [sec] to 30 [sec]) than when the shortest slope control is executed. In this slope control period, the string charge power instruction value of each of the strings St1 to Stx is updated so as to gradually change from the current value to the target value.

Here, the power storage system charge and discharge power instruction value is a total value of the string charge and discharge power instruction values of the respective strings St1 to Stx. Therefore, the string system controller SSC determines the string charge and discharge power instruction value of each of the strings St1 to Stx such that the string charge and discharge power instruction value of each of the strings St1 to Stx gradually changes from the current value to the target value, and the total value of the string charge and discharge power instruction values of the respective strings St1 to Stx gradually changes from the current value to the target value of the power storage system charge and discharge power instruction value.

The string system controller SSC determines an individual target value of the string charge and discharge power instruction value for each of the strings St1 to Stx before the start of the slope control period of the power storage system charge and discharge power. In addition, the string system controller SSC individually calculates a change amount ΔP1 of the string charge and discharge power instruction value of each predetermined cycle (for example, cycle of several seconds) for each of the strings St1 to Stx. The change amount ΔP1 is a value obtained by dividing a difference between the current value and the target value of the string charge and discharge power instruction value of each of the strings St1 to Stx into n equal parts, and is determined by a resolution. n is a value obtained by dividing a time of the slope control period by the above predetermined cycle.

The string system controller SSC calculates the string charge and discharge power instruction value of each of the strings St1 to Stx for each predetermined cycle in the slope control period of the power storage system charge and discharge power, and transmits the calculated string charge and discharge power instruction value to each of the string controllers SC1 to SCx by unicast communication. The string charge and discharge power instruction value is a value obtained by adding the above change amount ΔP1 to a current value that is assumed (hereinafter, referred to as assumed current value).

After transmitting the string charge and discharge power instruction value to all the string controllers SC1 to SCx, the string system controller SSC transmits a flag for updating the control of the power converters PCS1 to PCSx (hereinafter, referred to as PCS control update flag) to all the string controllers SC1 to SCx by broadcast communication.

When the standard slope control is executed, the string charge and discharge power instruction value of each of the strings St1 to Stx also converges to the target value at the time when the power storage system charge and discharge power instruction value converges to the target value. In the subsequent slope control period of the string charge and discharge power, the string charge and discharge power instruction value of each of the strings St1 to Stx gradually changes for the purpose of adjusting a balance of the string charge and discharge power of each of the strings St1 to Stx.

At the time of converging the power storage system charge and discharge power instruction value to the target value, the string system controller SSC determines the target value of the string charge and discharge power instruction value of each of the strings St1 to Stx for the purpose of adjusting a balance of the charge and discharge power of each of the strings St1 to Stx. At the same time, the string system controller SSC individually calculates a change amount ΔP2 of the string charge and discharge power instruction value of each predetermined cycle (for example, cycle of several seconds) for each of the strings St1 to Stx. A method for calculating the change amount ΔP2 is the same as that of the above change amount ΔP1.

The string system controller SSC transmits the string charge and discharge power instruction value of each of the strings St1 to Stx to each of the string controllers SC1 to SCx by unicast communication for each predetermined cycle in the slope control period of the string charge and discharge power. The string charge and discharge power instruction value is a value obtained by adding the above change amount ΔP2 to the assumed current value.

After transmitting the string charge and discharge power instruction value to all the string controllers SC1 to SCx by unicast communication, the string system controller SSC transmits the PCS control update flag to all the string controllers SC1 to SCx by broadcast communication.

As illustrated in the graph of FIG. 5, when the shortest slope control is executed, the power storage system charge and discharge power instruction value changes from the current value to the target value over a shorter slope control period (for example, 200 [msec] to 2 [sec]) than when the standard slope control is executed. In this slope control period, the string charge power instruction value of each of the strings St1 to Stx is updated so as to change from the current value to an intermediate target value in one cycle.

After the power storage system charge and discharge power instruction value is updated, the power storage system charge and discharge power instruction value is maintained, and the string charge and discharge power instruction value of each of the strings St1 to Stx is updated. The string charge and discharge power instruction value of each of the strings St1 to Stx is updated so as to gradually change from the intermediate target value to a final target value over the slope control period of the string charge and discharge power.

Here, the power storage system charge and discharge power instruction value is a total value of the string charge and discharge power instruction values of the respective strings St1 to Stx. Therefore, the string system controller SSC determines the string charge and discharge power instruction value of each of the strings St1 to Stx such that the string charge and discharge power instruction value of each of the strings St1 to Stx changes from the current value to the intermediate target value in one cycle, and the total value of the string charge and discharge power instruction values of the respective strings St1 to Stx changes from the current value to the target value of the power storage system charge and discharge power instruction value in one cycle.

The string system controller SSC determines the intermediate target values of the string charge and discharge power instruction values of all the strings St1 to Stx to be the same value uniformly before the start of the slope control period of the power storage system charge and discharge power. The string system controller SSC transmits the slope control period of the power storage system charge and discharge power and the intermediate target value of the string charge and discharge power instruction value to all the string controllers SC1 to SCx by broadcast communication. Thereafter, the string system controller SSC transmits the PCS control update flag to all the string controllers SC1 to SCx by broadcast communication.

Each of the string controllers SC1 to SCx controls each of the power converters PCS1 to PCSx according to the intermediate target value of the received string charge and discharge power instruction value, and updates the charge and discharge power. Here, for strings St1 to Stx in which the intermediate target value of the string charge and discharge power instruction value exceeds the charge and discharge power upper limit value, the corresponding string controllers SC1 to SCx limit the charge and discharge power to be less than the intermediate target value and equal to or less than the charge and discharge power upper limit value. In this case, the total value of the charge and discharge power of the respective strings St1 to Stx is less than the target value of the power storage system charge and discharge power. Therefore, in this case, the string system controller SSC corrects the target value of the power storage system charge and discharge power instruction value such that the charge and discharge power of the entire power storage system 1 satisfies a request of the power storage system controller PSC. This will be described in detail.

When the shortest slope control is executed, the string charge and discharge power instruction value of each of the strings St1 to Stx converges to the intermediate target value at the time when the power storage system charge and discharge power instruction value converges to the target value. Since the intermediate target value deviates from the final target value, the slope control of the string charge and discharge power is executed after the power storage system charge and discharge power instruction value converges to the target value. In the slope control period of the string charge and discharge power, the string charge and discharge power instruction value of each of the strings St1 to Stx gradually changes from the intermediate target value to the final target value for the purpose of adjusting a balance of the string charge and discharge power of each of the strings St1 to Stx.

At the time of converging the power storage system charge and discharge power instruction value to the target value, the string system controller SSC determines the final target value of the charge and discharge power instruction value of each of the strings St1 to Stx for the purpose of adjusting a balance of the charge and discharge power of each of the strings St1 to Stx. At the same time, the string system controller SSC individually calculates a change amount ΔP3 of the string charge and discharge power instruction value of each predetermined cycle (for example, cycle of several seconds) for each of the strings St1 to Stx. The change amount ΔP3 is a value obtained by dividing a difference between the intermediate target value and the final target value of the string charge and discharge power instruction value of each of the strings St1 to Stx into n equal parts, and is determined by a resolution.

The string system controller SSC transmits the string charge and discharge power instruction value of each of the strings St1 to Stx to all the string controllers SC1 to SCx by unicast communication for each predetermined cycle in the slope control period of the string charge and discharge power. The string charge and discharge power instruction value is a value obtained by adding the above change amount ΔP3 to the assumed current value.

After transmitting the string charge and discharge power instruction value to all the string controllers SC1 to SCx by unicast communication, the string system controller SSC transmits the PCS control update flag to all the string controllers SC1 to SCx by broadcast communication.

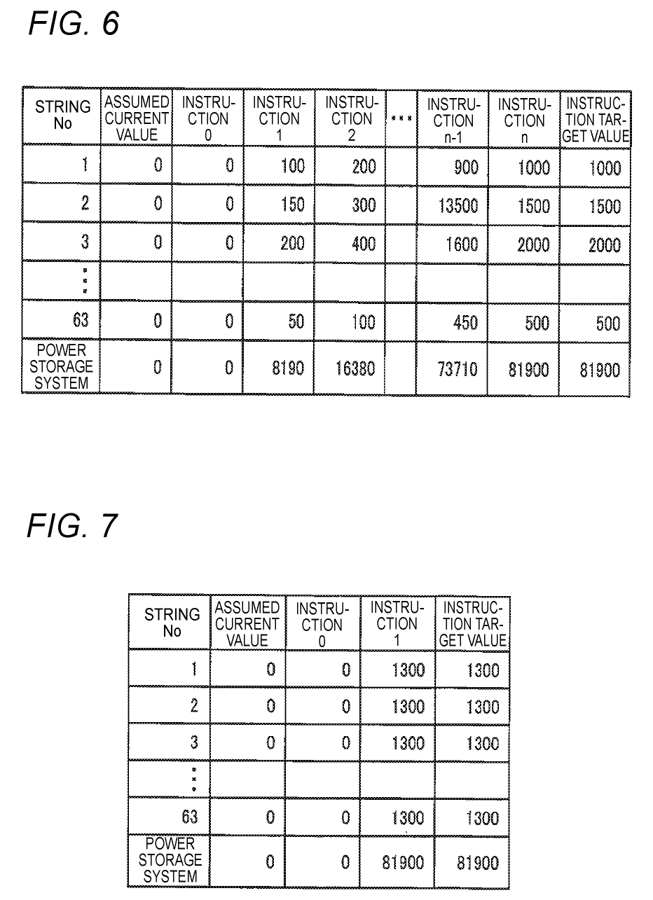

FIGS. 6 to 12 are tables for illustrating a method for determining the power storage system charge and discharge power instruction value and a string charge and discharge power instruction value of each of strings St1 to St63 in the slope control period of the power storage system charge and discharge power or the string charge and discharge power. In the tables of FIGS. 6 to 12, a discharge power instruction value of the entire power storage system 1 (hereinafter, referred to as power storage system discharge power instruction value) and a discharge power instruction value of each of the strings St1 to St63 (hereinafter, referred to as string discharge power instruction value) are shown. Hereinafter, a method for determining the power storage system discharge power instruction value and the string discharge power instruction value of each of the strings St1 to Stx in a slope control period of discharge power of the entire power storage system 1 (hereinafter, referred to as power storage system discharge power) or discharge power of each of the strings St1 to St63 (string discharge power) will be described. A method for determining a charge power instruction value of the entire power storage system 1 and a charge power instruction value of each of the strings St1 to Stx in a slope control period of charge power of the entire power storage system 1 will not be described, but is the same as the following description.

The table of FIG. 6 shows the power storage system discharge power instruction value and the string discharge power instruction value of each of the strings St1 to St63 at a start timing of the standard slope control in the slope control period of the power storage system discharge power. As shown in the table, at the start timing of the standard slope control in the slope control period of the power storage system discharge power, the string system controller SSC determines string discharge power instruction values of the respective strings St1 to St63 from "instruction 0" to "instruction n".

The string system controller SSC calculates the change amount ΔP1 by dividing a difference between the "assumed current value" and the value in the column of "instruction n" into n equal parts, and calculates values in the columns from "instruction 1" to "instruction n". The value in the column of "instruction 1" is a value obtained by adding the change amount ΔP1 to the "assumed current value", the value in the column of "instruction 2" is a value obtained by adding the change amount ΔP1 to the value in the column of "instruction 1", the value in the column of "instruction n-1" is a value obtained by adding the change amount ΔP1 to the value in the column of "instruction n-2", and the value in the column of "instruction n" is a value in the column of "instruction target value". In addition, the "assumed current value" is a value assumed by the string system controller SSC based on a string discharge instruction value transmitted by the string system controller SSC itself and a discharge upper limit value of each of the strings St1 to St63.

The string system controller SSC transmits the value in the column of "instruction 0" as the string discharge power instruction value to each of the string controllers SC1 to SC63 by unicast communication. Thereafter, the string system controller SSC repeatedly executes the following processes (1) to (4) for each predetermined cycle.

(1) The string system controller SSC substitutes the values in the columns from "instruction 1" to "instruction target value" into the column on a left side. That is, the string system controller SSC substitutes the value in the column of "instruction 1" into the column of "instruction 0", substitutes the value in the column of "instruction 2" into the column of "instruction 1", and substitutes the value of "instruction target value" into "instruction n".

(2) In a case where the power storage system discharge power instruction value is updated, the string system controller SSC changes the "instruction target value" according to the updated power storage system discharge power instruction value, and updates the values in the columns of "instruction 1" to "instruction n" according to the changed "instruction target value". In this case, the string system controller SSC calculates the change amount ΔP1 by dividing a difference between the "assumed current value" and the value in the column of "instruction n" into n equal parts, and calculates values in the columns from "instruction 1" to "instruction n".

(3) The string system controller SSC transmits the value in the column of "instruction 0" as the string discharge power instruction value to each of the string controllers SC1 to SC63 by unicast communication.

(4) The string system controller SSC transmits a PCS control update flag to all the string controllers SC1 to SC63 by broadcast communication.

The table of FIG. 7 shows the power storage system discharge power instruction value and the string discharge power instruction value of each of the strings St1 to St63 at a start timing of the shortest slope control in the slope control period of the power storage system discharge power. As shown in the table, at the start timing of the shortest slope control in the slope control period of the power storage system discharge power, the string system controller SSC determines the string discharge power instruction value of each of the strings St1 to St63 for "instruction 0" and "instruction 1". The value in the column of "instruction 0" is the value in the column of "assumed current value", and the value in the column of "instruction 1" is the value in the column of "instruction target value". In addition, the value in the column of "instruction target value" is a value obtained by dividing the power storage system discharge power instruction value by the number of strings St1 to St63 that can discharge power.

The string system controller SSC transmits the value in the column of "instruction 0" as the string discharge power instruction value to all the string controllers SC1 to SC63 by broadcast communication. Thereafter, the string system controller SSC executes the following processes (1) to (4).

(1) The string system controller SSC substitutes the values in the columns from "instruction 1" to "instruction target value" into the column on a left side. That is, the string system controller SSC substitutes the value in the column of "instruction 1" into the column of "instruction 0", and substitutes the value in the column of "instruction target value" into the column of "instruction 1". In a case where the column of "instruction 2" exists, a value in the column of "instruction 2" is substituted into the column of "instruction 1", and the value of "instruction target value" is substituted into the column of "instruction 2".

(2) The string system controller SSC transmits the value in the column of "instruction 0" as the string discharge power instruction value to all the string controllers SC1 to SC63 by broadcast communication. The transmission of the string discharge power instruction value to the string controllers SC1 to SC63 corresponding to the strings St1 to St63 that do not perform the discharge operation is not executed. In addition, in a case where the power storage system discharge power instruction value is updated during execution of the shortest slope control of the power storage system discharge power, the string system controller SSC transmits the string discharge power instruction value to the string controllers SC1 to SC63 by broadcast communication based on the power storage system discharge power instruction value before the update, and then executes a process corresponding to the power storage system discharge power instruction value after the update. Here, the string system controller SSC may interrupt the process corresponding to the power storage system discharge power instruction value before the update and execute the process corresponding to the power storage system discharge power instruction value after the update.

(3) The string system controller SSC transmits a PCS control update flag to all the string controllers SC1 to SC63 by broadcast communication. The transmission of the PCS control update flag to the string controllers SC1 to SC63 corresponding to the strings St1 to St63 that do not perform the discharging operation is not executed.

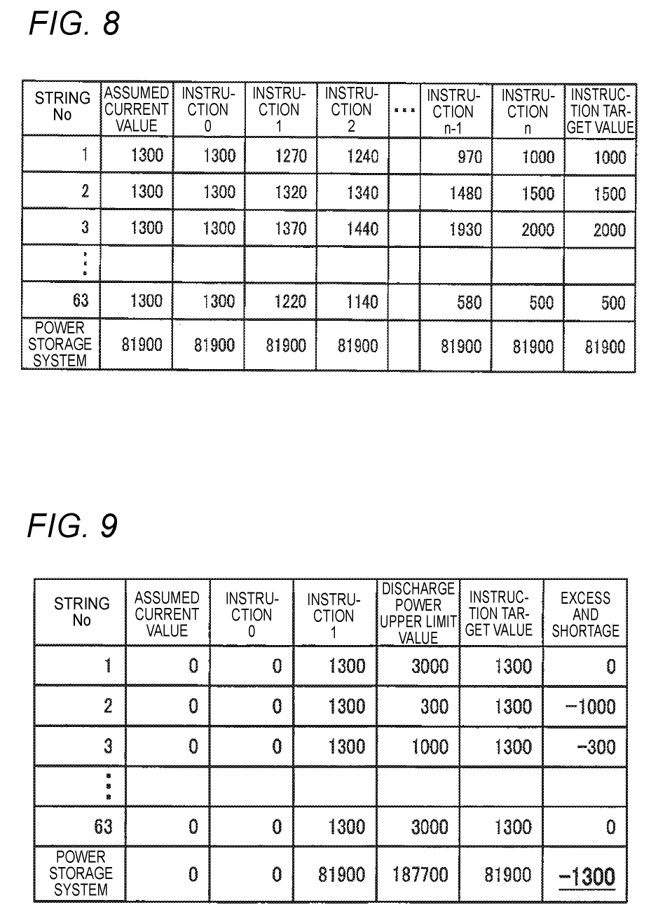

(4) The string system controller SSC executes the standard slope control of the string discharge power shown in the table of FIG. 8, maintains the power storage system discharge power, and adjusts a balance of the string discharge power of each of the strings St1 to St63.

The table of FIG. 8 shows the power storage system discharge power instruction value and the string discharge power instruction value of each of the strings St1 to St63 at a start timing of the standard slope control of the string discharge power. As shown in the table, at the start timing of the standard slope control in the slope control period of the string discharge power, the string system controller SSC determines the string discharge power instruction value of each of the strings St1 to St63 from "instruction 0" to "instruction n".

The string system controller SSC calculates the change amount ΔP3 by dividing a difference between the "assumed current value" and the value in the column of "instruction n" into n equal parts, and calculates values in the columns from "instruction 1" to "instruction n". The value in the column of "instruction 1" is a value obtained by adding the change amount ΔP3 to the "assumed current value", the value in the column of "instruction 2" is a value obtained by adding the change amount ΔP3 to the value in the column of "instruction 1", the value in the column of "instruction n-1" is a value obtained by adding the change amount ΔP3 to the value in the column of "instruction n-2", and the value in the column of "instruction n" is a value in the column of "instruction target value". In addition, the "assumed current value" is a value assumed by the string system controller SSC based on the string discharge instruction value (value in column of "instruction target value" in table of FIG. 7) transmitted by the string system controller SSC itself and a string discharge upper limit value of each of the strings St1 to St63.

The string system controller SSC transmits the value in the column of "instruction 0" as the string discharge power instruction value to each of the string controllers SC1 to SC63 by unicast communication. Thereafter, the string system controller SSC repeatedly executes the following processes (1) to (4) for each predetermined cycle.

(1) The string system controller SSC substitutes the values in the columns from "instruction 1" to "instruction target value" into the column on a left side. That is, the string system controller SSC substitutes the value in the column of "instruction 1" into the column of "instruction 0", substitutes the value in the column of "instruction 2" into the column of "instruction 1", and substitutes the value of "instruction target value" into "instruction n".

(2) In a case where the power storage system discharge power instruction value is updated, the string system controller SSC shifts from the standard slope control of the string discharge power to the shortest slope control of the power storage system discharge power.

(3) The string system controller SSC transmits the value in the column of "instruction 0" as the string discharge power instruction value to each of the string controllers SC1 to SC63 by unicast communication.

(4) The string system controller SSC transmits a PCS control update flag to all the string controllers SC1 to SC63 by broadcast communication.

The tables of FIGS. 9 to 11 show the power storage system discharge power instruction value and the string discharge power instruction value of each of the strings St1 to St63 at the start timing of the shortest slope control in the slope control period of the power storage system discharge power. Here, in examples shown in the tables of FIGS. 9 to 11, the strings St2 and St3 in which the "discharge power upper limit value" is less than the "instruction target value" are present.

As shown in the table of FIG. 9, at the start timing of the shortest slope control in the slope control period of the power storage system discharge power, the string system controller SSC determines the string discharge power instruction value of each of the strings St1 to St63 for "instruction 0" and "instruction 1". The value in the column of "instruction 0" is the value in the column of "assumed current value", and the value in the column of "instruction 1" is the value in the column of "instruction target value". In addition, the value in the column of "instruction target value" is a value obtained by dividing the power storage system discharge power instruction value by the number of strings St1 to St63 that can discharge power.

The string system controller SSC compares the value in the column of "instruction target value", the value in the column of "instruction 1", and the value in the column of "discharge power upper limit value", and calculates a shortage or an excess of the string discharge power that can be output from each of the strings St1 to St63 with respect to the value in the column of "instruction target value". Here, in a case where the value in the column of "instruction target value" is smaller than the value in the column of "discharge power upper limit value" ("instruction target value" < "discharge power upper limit value"), the excess of the string discharge power that can be output from each of the strings St1 to St63 is 0 or more ("instruction 1" - "instruction target value" ≥ 0). On the other hand, in a case where the value in the column of "instruction target value" is equal to or greater than the value in the column of "discharge power upper limit value" ("instruction target value" ≥ "discharge power upper limit value"), the shortage of the string discharge power that can be output from each of the strings St1 to St63 is equal to or greater than 0 ("instruction target value" - "instruction 1" ≥ 0).

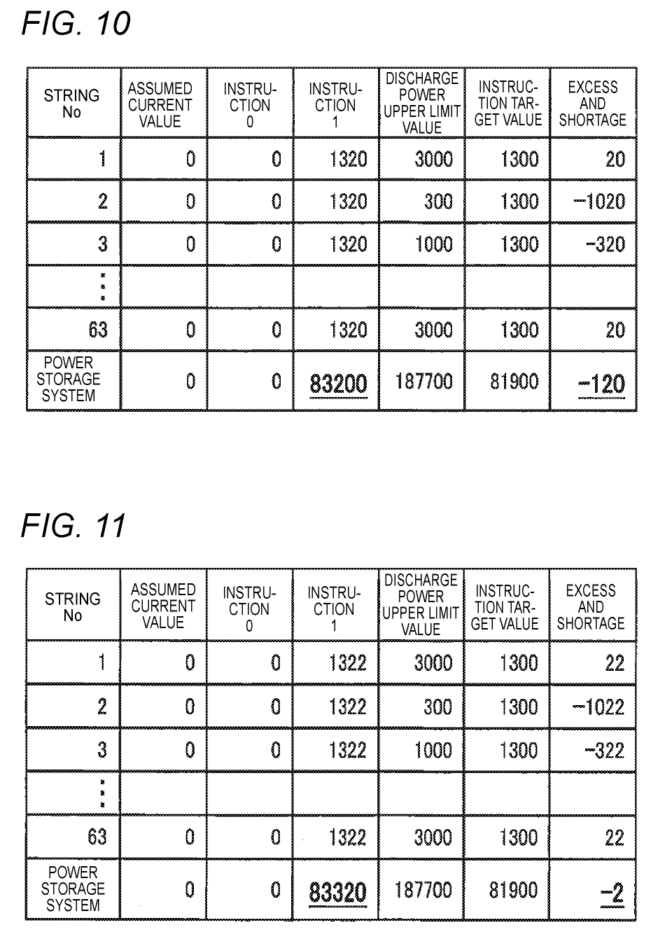

As shown in the tables of FIGS. 10 and 11, the string system controller SSC corrects the power storage system discharge power instruction value, and corrects the value in the column of "instruction 1" of the string discharge power instruction value of each of the strings St1 to St63 according to the correction of the power storage system discharge power instruction value. That is, the string system controller SSC corrects the power storage system discharge power instruction value such that a total value of the shortage and the excess of the string discharge power of the respective strings St1 to St63 (-1300 in FIG. 9 and -120 in FIG. 10) approaches 0. In addition, the string system controller SSC calculates the value in the column of "instruction 1" by dividing the corrected power storage system discharge power instruction value by the number of the strings St1 to St63 that can discharge power, and substitutes the calculated value into the column of "instruction 1". The above processes are repeated a necessary number of times until the total value of the shortage and the excess of the string discharge power of the respective strings St1 to St63 becomes 0.

The string system controller SSC transmits the value in the column of "instruction 0" shown in the table of FIG. 11 as the string discharge power instruction value to all the string controllers SC1 to SC63 by broadcast communication. Thereafter, the string system controller SSC executes the following processes (1) to (4).

(1) The string system controller SSC substitutes the values in the columns from "instruction 1" to "instruction target value" into the column on a left side. That is, the string system controller SSC substitutes the value in the column of "instruction 1" into the column of "instruction 0". In a case where the column of "instruction 2" exists, a value in the column of "instruction 2" is substituted into the column of "instruction 1", and the value of "instruction target value" is substituted into the column of "instruction 2".

(2) The string system controller SSC transmits the value in the column of "instruction 0" as the string discharge power instruction value to all the string controllers SC1 to SC63 by broadcast communication. The transmission of the string discharge power instruction value to the string controllers SC1 to SC63 corresponding to the strings St1 to St63 that do not perform the discharge operation is not executed.

(3) The string system controller SSC transmits a PCS control update flag to all the string controllers SC1 to SC63 by broadcast communication. The transmission of the PCS control update flag to the string controllers SC1 to SC63 corresponding to the strings St1 to St63 that do not perform the discharging operation is not executed. Here, for the strings St2 and St3 in which the discharge power upper limit value is lower than the instruction target value, the corresponding string controllers SC2 and SC3 control the power converters PCS2 and PCS3 such that the string discharge power equal to or lower than the discharge power upper limit value is output.

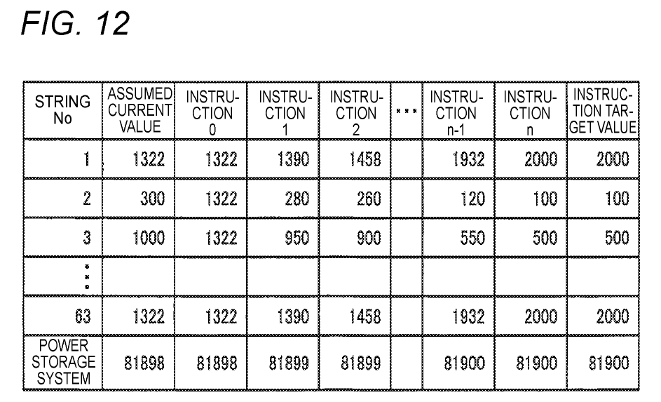

(4) The string system controller SSC executes the standard slope control of the string discharge power shown in the table of FIG. 12.

The table of FIG. 12 shows the power storage system discharge power instruction value and the string discharge power instruction value of each of the strings St1 to St63 at the start timing of the standard slope control of the string discharge power.

As shown in the table, at the start timing of the standard slope control in the slope control period of the string discharge power, the string system controller SSC determines the string discharge power instruction value of each of the strings St1 to St63 from "instruction 0" to "instruction n".

The string system controller SSC calculates the change amount ΔP3 by dividing a difference between the "assumed current value" and the value in the column of "instruction n" into n equal parts, and calculates values in the columns from "instruction 1" to "instruction n". The value in the column of "instruction 1" is a value obtained by adding the change amount ΔP3 to the "assumed current value", the value in the column of "instruction 2" is a value obtained by adding the change amount ΔP3 to the value in the column of "instruction 1", the value in the column of "instruction n-1" is a value obtained by adding the change amount ΔP3 to the value in the column of "instruction n-2", and the value in the column of "instruction n" is a value in the column of "instruction target value". In addition, the "assumed current value" is the lower one of the value in the column of "instruction 1" and the value in the column of "discharge power upper limit value" shown in the table of FIG. 11.

The string system controller SSC transmits the value in the column of "instruction 0" as the string discharge power instruction value to each of the string controllers SC1 to SC63 by unicast communication. Thereafter, the string system controller SSC repeatedly executes the following processes (1) to (4) for each predetermined cycle while maintaining the power storage system discharge power.

(1) The string system controller SSC substitutes the values in the columns from "instruction 1" to "instruction target value" into the column on a left side. That is, the string system controller SSC substitutes the value in the column of "instruction 1" into the column of "instruction 0", substitutes the value in the column of "instruction 2" into the column of "instruction 1", and substitutes the value of "instruction target value" into "instruction n".

(2) In a case where the power storage system discharge power instruction value is updated, the string system controller SSC shifts from the standard slope control of the string discharge power to the shortest slope control of the power storage system discharge power.

(3) The string system controller SSC transmits the value in the column of "instruction 0" as the string discharge power instruction value to each of the string controllers SC1 to SC63 by unicast communication.

(4) The string system controller SSC transmits a PCS control update flag to all the string controllers SC1 to SC63 by broadcast communication.

As described above, the storage battery control device 2 according to the present embodiment includes the plurality of string controllers SC1 to SCx provided for the respective strings St1 to Stx, the power storage system controller PSC, and the string system controller SSC that communicates with the plurality of string controllers SC1 to SCx. Each of the string controllers SC1 to SCx controls the string charge and discharge power (second charge and discharge power instruction value) of the corresponding string St1 to Stx. The string system controller SSC receives the power storage system charge and discharge power instruction value (first charge and discharge power instruction value) from the power storage system controller PSC, calculates the string charge and discharge power instruction value for each of the strings St1 to Stx according to the received power storage system charge and discharge power instruction value, and transmits the calculated string charge and discharge power instruction value to the corresponding string controllers SC1 to SCx.

Here, the string system controller SSC changes the power storage system charge and discharge power from the current value to the target value by selectively executing one of the standard slope control and the shortest slope control in the slope control period of the power storage system charge and discharge power. The string system controller SSC adjusts the string charge and discharge power of the plurality of strings St1 to Stx by executing the standard slope control in the slope control period of the string charge and discharge power after executing the standard slope control or the shortest slope control.

In the standard slope control in the slope control period of the power storage system charge and discharge power, the string system controller SSC individually calculates the string charge and discharge power instruction value of each predetermined cycle for each of the string controllers SC1 to SCx according to the power storage system charge and discharge power instruction value received from the power storage system controller PSC. The string system controller SSC individually transmits the calculated string charge and discharge power instruction value to each of the string controllers SC1 to SCx for each predetermined cycle. As a result, at the time of the update of the power storage system charge and discharge power instruction value, the power storage system charge and discharge power can gradually change over any time, and a rapid change in the power storage system charge and discharge power can be prevented.

In the shortest slope control in the slope control period of the power storage system charge and discharge power, the string system controller SSC calculates a string charge and discharge power instruction value common to the plurality of string controllers SC1 to SCx according to the power storage system charge and discharge power instruction value received from the power storage system controller PSC. The string system controller SSC simultaneously transmits the calculated common string charge and discharge power instruction value to the plurality of string controllers SC1 to SCx. Accordingly, the responsiveness at the time of the update of the power storage system charge and discharge power instruction value can be improved.

In the standard slope control in the slope control period of the power storage system charge and discharge power, the string system controller SSC individually transmits the string charge and discharge power instruction value individually calculated for each of the string controllers SC1 to SCx to each of the string controllers SC1 to SCx by unicast communication for each predetermined cycle. As a result, at the time of completion of the slope control of the power storage system charge and discharge power, the string charge and discharge power of each of the strings St1 to Stx can be converged to the target value.

On the other hand, in the shortest slope control in the slope control period of the power storage system charge and discharge power, the string system controller SSC simultaneously transmits the string charge and discharge power instruction value common to the plurality of string controllers SC1 to SCx to the plurality of string controllers SC1 to SCx by broadcast communication. Accordingly, the slope control of the charge and discharge power of the power storage system can be completed in a shorter time than the standard slope control.

In a case where the string system controller SSC receives the updated power storage system charge and discharge power instruction value from the power storage system controller PSC during the execution of the standard slope control of the string charge and discharge power after the execution of the shortest slope control of the power storage system charge and discharge power, the string system controller SSC shifts from the standard slope control of the string charge and discharge power to the shortest slope control of the power storage system charge and discharge power. Accordingly, the responsiveness to the update of the power storage system charge and discharge power can be improved.

When executing the shortest slope control of the power storage system charge and discharge power, the string system controller SSC calculates a difference between an upper limit value of the string charge and discharge power and the string charge and discharge power instruction value for each of the strings St1 to Stx, and corrects the power storage system charge and discharge power instruction value such that a total value of the differences of the plurality of strings St1 to Stx is reduced. The string system controller SSC calculates the string charge and discharge power instruction value common to the plurality of string controllers SC1 to SCx according to the corrected power storage system charge and discharge power instruction value. The string system controller SSC simultaneously transmits the calculated common string charge and discharge power instruction value to the plurality of string controllers SC1 to SCx. Accordingly, even in a case where strings St1 to Stx in which the upper limit value of the string charge and discharge power is lower than the string charge and discharge power instruction value are present, it is possible to bring actual power storage system charge and discharge power close to the power storage system charge and discharge power instruction value received from the power storage system controller PSC while controlling the string charge and discharge power of the strings St1 to Stx to be equal to or lower than the upper limit value. It is not essential to correct the power storage system charge and discharge power instruction value such that the total value of the differences of the plurality of strings St1 to Stx is reduced, and the string charge and discharge power instruction value may be corrected such that the total value of the differences of the plurality of strings St1 to Stx is reduced. The string charge and discharge power instruction value in this case is a value common to the plurality of string controllers SC1 to SCx.

Here, while the charge and discharge power upper limit value is an estimated value of the charge and discharge power that can be charged and discharged from the strings St1 to Stx, charge and discharge power that can be actually charged and discharged from the strings St1 to Stx may be equal to or greater than the estimated value. In this case, when the string charge and discharge power instruction value exceeding the charge and discharge power upper limit value as the estimated value is transmitted from the string system controller SSC and the strings St1 to Stx execute charge and discharge according to the transmitted string charge and discharge power instruction value, an error occurs between the charge and discharge power of the power storage system 1 and the power storage system charge and discharge power instruction value. Therefore, when executing the shortest slope control of the power storage system charge and discharge power, the string controllers SC1 to SCx control the charge and discharge power to be equal to or less than the charge and discharge power upper limit value of each of the strings St1 to Stx according to the string charge and discharge power instruction value transmitted from the string system controller SSC. Accordingly, an error between the charge and discharge power of the power storage system 1 and the power storage system charge and discharge power instruction value can be reduced.

In the standard slope control of the power storage system charge and discharge power or the string system charge and discharge power, the string system controller SSC sets the string charge and discharge power instruction value of each predetermined cycle such that the string charge and discharge power instruction value gradually changes from the current value to the target value. As a result, at the time of the update of the power storage system charge and discharge power instruction value, the power storage system charge and discharge power can gradually change over any time, and a rapid change in the power storage system charge and discharge power can be prevented.

After transmitting the string charge and discharge power instruction value to the plurality of string controllers SC1 to SCx in the standard slope control or the shortest slope control, the string system controller SSC simultaneously transmits an execution instruction of the control of the power converters PCS1 to PCSx to the plurality of string controllers SC1 to SCx by broadcast communication. Accordingly, a communication time of the control instruction of the power converters PCS1 to PCSx can be shortened, and the responsiveness to the update of the power storage system charge and discharge power can be improved.

Although the present disclosure has been described above based on the above embodiment, the present disclosure is not limited to the above embodiment. Modifications may be made without departing from the gist of the present disclosure, or publicly known or well-known techniques may be appropriately combined.

For example, in the above-described embodiments, the string system controller SSC transmits the string charge and discharge power instruction value to the string controllers SC1 to SCx. However, the power storage system controller PSC and the string system controller SSC may be integrated into one controller, and the integrated controller may transmit the string charge and discharge power instruction value to the string controllers SC1 to SCx. In addition, any of the plurality of string controllers SC1 to SCx may be a master controller and the others may be slave controllers, and the master controller may transmit the string charge and discharge power instruction value to the slave controllers.

Although various embodiments have been described above, it is needless to say that the present disclosure is not limited to these examples. It is apparent that those skilled in the art can come up with various modifications or corrections within the scope of the claims, and it is understood that the modifications or corrections naturally fall within the technical scope of the present disclosure. In addition, components described in the above embodiments may be combined freely without departing from the spirit of the invention.

The present application is based on a Japanese patent application (No. 2023-120934) filed on July 25, 2023, the contents of which are incorporated herein by reference.

### REFERENCE SIGNS LIST

1: power storage system

2: storage battery control device

PCS1: power converter

PCS2: power converter

PCS3: power converter

PCSx: power converter

PSC: power storage system controller (host control unit)

SC1: string controller (first control unit)

SC2: string controller (first control unit)

SC3: string controller (first control unit)

SC63: string controller (first control unit)

SCx: string controller (first control unit)

SSC: string system controller (second control unit)

St1: string (power storage string)

St2: string (power storage string)

St3: string (power storage string)

St4: string (power storage string)

St5: string (power storage string)

St63: string (power storage string)

Stx: string (power storage string)

What is claimed is:

1. A storage battery control device that controls a power storage system including a plurality of power storage strings connected in parallel, the storage battery control device comprising:
a plurality of first control units that are provided for each of the power storage strings and are configured to control charge and discharge power of a corresponding power storage string; and
a second control unit configured to receive a first charge and discharge power instruction value, which is an instruction value of charge and discharge power of the entire power storage system, from a host control unit, calculate a second charge and discharge power instruction value, which is an instruction value of charge and discharge power of each power storage string, according to the received first charge and discharge power instruction value, and transmit the calculated second charge and discharge power instruction value to a corresponding first control unit, wherein
the second control unit is configured to
change the charge and discharge power of the entire power storage system from a current value to a target value by selectively executing one of a first control and a second control, the first control individually calculating the second charge and discharge power instruction value of each predetermined cycle for each of the first control units according to the first charge and discharge power instruction value received from the host control unit and individually transmitting the calculated second charge and discharge power instruction value to the first control unit for each predetermined cycle, the second control calculating the second charge and discharge power instruction value common to the plurality of first control units according to the first charge and discharge power instruction value received from the host control unit and simultaneously transmitting the calculated common second charge and discharge power instruction value to the plurality of first control units, and
execute, after the first control or the second control is executed, a third control of individually calculating the second charge and discharge power instruction value for each of the first control units and individually transmitting the calculated second charge and discharge power instruction value to the first control unit to adjust the charge and discharge power of the plurality of power storage strings.

2. The storage battery control device according to claim 1, wherein
the second control unit is configured to transmit the calculated second charge and discharge power instruction value to the first control unit by unicast communication for each predetermined cycle when the first control and the third control are executed, and transmit the calculated common second charge and discharge power instruction value to the plurality of first control units simultaneously by broadcast communication when the second control is executed.

3. The storage battery control device according to claim 1, wherein
the second control unit is configured to execute the second control in a case where an updated first charge and discharge power instruction value is received from the host control unit during execution of the third control after the second control is executed.

4. The storage battery control device according to claim 1, wherein
the second control unit is configured to, when the second control is executed, calculate a difference between a charge and discharge power upper limit value and the second charge and discharge power instruction value for each of the power storage strings, calculate the second charge and discharge power instruction value common to the plurality of first control units that reduce a total value of the differences of the plurality of power storage strings, and simultaneously transmit the calculated common second charge and discharge power instruction value to the plurality of first control units.

5. The storage battery control device according to claim 4, wherein
the first control unit is configured to, when the second control is executed, control the charge and discharge power to be equal to or less than the charge and discharge power upper limit value for each of the power storage strings according to the second charge and discharge power instruction value transmitted from the second control unit.

6. The storage battery control device according to claim 1, wherein
the second charge and discharge power instruction value of each predetermined cycle calculated in the first control gradually changes from a current value to a target value.

7. The storage battery control device according to claim 1, wherein
the power storage system includes a plurality of power converters that are provided for each of the power storage strings and are controlled by the first control unit to convert charge and discharge power of the power storage strings, and
the second control unit is configured to transmit the second charge and discharge power instruction value to the plurality of first control units in the first control, the second control, or the third control, and then simultaneously transmit an execution instruction of a control of the power converters to the plurality of the first control units by broadcast communication.

8. A power storage system comprising:
a plurality of power storage strings connected in parallel; and
a storage battery control device that controls charge and discharge power of the plurality of power storage strings, wherein
the storage battery control device includes
a plurality of first control units that are provided for each of the power storage strings and are configured to control charge and discharge power of a corresponding power storage string, and
a second control unit configured to receive a first charge and discharge power instruction value, which is an instruction value of charge and discharge power of the entire power storage system, from a host control unit, calculate a second charge and discharge power instruction value, which is an instruction value of charge and discharge power of each power storage string, according to the received first charge and discharge power instruction value, and transmit the calculated second charge and discharge power instruction value to a corresponding first control unit, and
the second control unit is configured to
change the charge and discharge power of the entire power storage system from a current value to a target value by selectively executing one of a first control and a second control, the first control individually calculating the second charge and discharge power instruction value of each predetermined cycle for each of the first control units according to the first charge and discharge power instruction value received from the host control unit and individually transmitting the calculated second charge and discharge power instruction value to the first control unit for each predetermined cycle, the second control calculating the second charge and discharge power instruction value common to the plurality of first control units according to the first charge and discharge power instruction value received from the host control unit and simultaneously transmitting the calculated common second charge and discharge power instruction value to the plurality of first control units, and
execute, after the first control or the second control is executed, a third control of individually calculating the second charge and discharge power instruction value for each of the first control units and individually transmitting the calculated second charge and discharge power instruction value to the first control unit to adjust the charge and discharge power of the plurality of power storage strings.
